(19) United States
(12) Patent Application Publication
(10) Pub. No.: US 2015/0106219 A1
(43) Pub. Date: Apr. 16, 2015

(54) EXTEN DESIGN PROJECTS

(71) Applicant: Na In Kim, Toronto (CA)

(72) Inventor: Na In Kim, Toronto (CA)

(73) Assignee: EXTEN, Toronto, ON (CA)

(21) Appl. No.: 13/261,953

(22) PCT Filed: May 24, 2012
(86) PCT No.: PCT/CA2012/000511

§ 371 Date: Sep. 15, 2014

(51) Int. Cl. G06Q 30/06; G06Q 50/18; G06Q 30/02

(52) U.S. Cl. CPC G06Q 30/0601; G06Q 30/0277; G06Q 50/184
USPC 705/26.1

(57) ABSTRACT

Exten design projects is a cohesive unit of on and offline integrated business that is consisted of multiple business components that are inter-related with each other to generate revenue streams from those components. Exten design projects extends its online graphic business platform, which allows users to display information about product or service of graphic design projects for clients to choose from and for clients to order the itemized product or service online, to variety of commercial opportunity for the industry of software, law, arts, design, advertising, marketing and employment services. The applied computer science to user registration, intellectual property dispute, online trade, marketing, and advertising enables each of the business component to work efficiently as a united whole.

### TECHNICAL FIELD

Computer Science, Law, Arts, Design, Business

### BACKGROUND ART

Exten design projects began as a software that transmits purchase orders of graphic design projects online by using predesigned forms, of which name was design projects online .net. The software accompanies an integrated application that manages registered client-based users by the format of membership. It enables project managers, who use the software for their graphic design business, to communicate with the users for the projects ordered and to administer transaction data.

### DISCLOSURE OF INVENTION

Exten design projects is a cohesive unit of on and offline integrated business that is consisted of multiple business components that are inter-related with each other to generate revenue streams from those components. The business components are graphic design, intellectual property law, business administration, advertising, marketing, and software development. Exten design projects extends its boundary of platform of membership from design projects online .net to contain more business components that are integrated with each other thus, includes added features of software for the unit of business and its integrated business management application.

### BEST MODE FOR CARRYING OUT THE INVENTION OR, WHERE APPROPRIATE MODE(S) FOR CARRYING OUT THE INVENTION

Membership administration 1.0: software programming, mathematical logic
Membership administration 2.0: software programming, mathematical logic, manual review by professional
   Intellectual property administration 1.0: software programming, mathematical logic
   Intellectual property administration 2.0: manual review by professional
   Design portfolio administration: manual review by professional
Membership administration 3.0: software programming, manual review by professional
Membership administration 3.1: software programming, manual review by professional
Membership administration 4.0: software programming
Membership administration 5.0: software programming, manual review by professional
Trade and venues: software programming, manual review by professional
   Design and design project advertising: software programming
   Parts of design projects online .net: software programming
   Intellectual property administration 3.0: software programming
   Intellectual property administration 4.0: manual review by professional
   Business advertising: software programming
Consumer marketing: software programming
Business management: software programming, manual review by professional

### INDUSTRIAL APPLICABILITY

Software, law, arts, design, advertising, marketing, employment service
A. Graphic designer and business guest membership administration
B. Intellectual property administration
C. Designer portfolio administration
D. Graphic designer and business official membership administration
E. Advertising
F. Trade
G. Software application sales
H. Intellectual property administration
I. Consumer marketing, project management administration, financial transaction administration

1. Prior art: design projects online .net
A. Online graphic business platform that allows the software licensee to display information about product or service of graphic design projects for clients to choose from and for registered clients to order the itemized product or service by using predesigned purchase order form online.
I. Integrated business management application that administers client data, which includes the data of administration, sales, projects, and raw information generated by the use of software

2. Features added
A. Business connector: frame of business concept that binds registered individuals or employees, who create original art as well as who provide creative services, and businesses together with a commercial agreement for both parties to trade among each other on and off line
B. Easy registration: registration process that utilizes both mathematical logic and software programming to categorize identity of registrars
C. Intellectual property dispute: design and art portfolio copyright dispute system that utilizes both software programming and mathematical logic as part of registration process
D. Decision maker: system that enables businesses to make best decisions selecting designers or artists for each projects utilizing software programming and information technology
E. Lie detector: design and/or art creator cross reference system that utilizes software programming
F. Trade venue: trade platform that allows users to buy and sell products among the user group
G. Advertising platform:
A. Between the licensees of prior art and businesses: cross tendering platform that allows users to advertise and accept the tenders of services and products
B. Businesses to businesses: cross impression advertising among, by nature, non-competing businesses
H. Marketing platform: consumer marketing platform that utilizes the advertising and trade venue platform

3. General inventive concept: Exten design projects
a cohesive unit of on and offline integrated business that is consisted of administration, intellectual property dispute, arts and design service, online trade, advertising, and marketing, of which nature of each business is so linked with each other that they must exist together at the same time in a peaceful way among each components and/or venues and the unit of business, and of which components utilize computer science
